(19) United States
(12) Patent Application Publication
(10) Pub. No.: US 2005/0183687 A1
(43) Pub. Date: Aug. 25, 2005

(54) Timing gear flexible coupling

(76) Inventor: Thomas Agapiades, Yuba City, CA (US)

Correspondence Address: THOMAS AGAPIADES, 744 BRIDGE STREET, YUBA CITY, CA, 95991, US

(21) Appl. No.: 10/783,110

(22) Filed: Feb. 19, 2004

(51) Int. Cl. F01L 7/00; F16H 57/00

(52) U.S. Cl. 123/190.14; 74/411

(57) ABSTRACT

The invention is a timing gear flexible coupling for operation of a disc valve rotatively mounted in an internal combustion engine cylinder head. Rotation of the disc valve periodically opens and closes a plurality of exhaust and intake ports in the stationary stator of the cylinder head in a sequential manner corresponding to the alternating order of the engine of the engine thermodynamic pressure cycle. The purpose of the flexible coupling is to momentarily slow the rotational velocity of the disc valve during the highest peak pressure of the engine combustion stroke during the ignition spike which exponentially reduces the rubbing contact frictional energy between the disc and stator. The primary purpose of the timing gear flexible coupling is to reduce the shearing impact across the lubricating film at the sliding interface between the disc valve and stationary stator comprising the engine intake and exhaust ports thereby decreasing frictional surface wear and permitting faster engine acceleration.

### BACKGROUND OF THE INVENTION

The invention comprises an intervening resilient member that is mounted between the hub of an engine timing gear and timing shaft rotatively mounted in the cylinder head of a disc valve engine. The resilient member serves as a flexible coupling between the timing gear and the timing shaft. Flexible couplings are most generally used to provide shaft torque flexibility under heavy starting loads or to offset shaft misalignment. The resilient member in the present invention, while providing flexibility under torque loads is used in a unique manner that constitutes the novelty of this invention. The resilient member provides a means of lowering peak friction loads at the sliding interface between a stationary stator surface and the surface of a rotating disc valve operating within the fluctuating pressure field of an engine combustion chamber.

Rotation of the said disc valve mounted within the engine combustion chamber periodically opens and closes a plurality of exhaust and intake ports in the stationary stator of the engine cylinder head in a sequential manner corresponding to the alternating order of the engine thermodynamic pressure cycle. The flexible coupling between the said timing gear and said timing shaft momentarily slows the rotational velocity of the disc valve during the highest peak pressure of the engine combustion stroke at the point of the ignition spike thereby reducing the sliding contact frictional energy between the disc and stator surfaces which is exponentially at its highest point during this brief period.

At the few milliseconds of peak combustion pressure ignition spike the resilient member between the hub of the said timing gear and said timing shaft is slightly compressed causing the said timing shaft to rotate slower than said timing gear for a brief instant over a small millisecond increment of rotation and thereby transmitting a slowing motion to the disc valve rotation. This slowing motion is hardly measurable, but at the molecular interface of the lubricating film between the surfaces in slidable contact the shearing impact across the said interface is lessened exponentially as a function of the contacting velocity. Absorption of peak torque loads on the timing shaft by the resilient member during the peak combustion pressures when the sliding contact friction between the disc valve and stator are highest will lessen wear between the two surfaces and lower the potential for galling.

The resilient member is an elastic material capable of fully responding over the engine operating frequency. Formulation of rubber resilient members with extenders or catalyst accelerators will stiffen the response in a manner that permits full recovery after each compression and will not couple with the engine's natural frequency. The resilient member may be manufactured from any material which has the physical properties of sustained response of rapid compression loads with rapid recovery and good storage durability and with long term fatigue capability under heavy load.

### SUMMARY OF THE INVENTION

The invention is a flexible coupling comprising an intervening resilient member placed between the hub of a timing gear and the timing shaft of a rotary disc valve engine. At the peak of the combustion stroke, during the ignition spike, the said resilient member is compressed to its fullest extent by the cylinder combustion pressure bearing against the outer surfaces of the said disc valve pushing it with greater force against the stationary stator mounted in the cylinder head. This causes the torque on the timing shaft to increase significantly as the sliding friction between the said disc valve and stator surface increase. The increase in torque of the timing shaft is partially stored in the resilient member and returned to the system when the cylinder pressure is lowered. Thus the rubbing friction between the said disc valve and said stator does not effect engine speed and acceleration to the same extent as a hard coupled system.

It is the primary objective of the invention to lower the compressive bearing load between the interfacing surfaces of the disc valve and stator during the combustion ignition pressure spike event and thereby reduce the shearing impact on the lubricating film within the said interface reducing the sliding friction at this point in the engine cycle.

It is yet another objective of the invention to lower the disc rotational friction load to quicken engine acceleration response.

### BRIEF DESCRIPTION OF THE DRAWINGS

Drawings are presented which show the engine valve timing gear and its placement in the engine power train and the method of placing a resilient member between the said engine valve timing gear and the timing shaft to provide a flexible coupling with the engine disc valve.

FIG. 1 Shows the moving components of the engine power train and shows the point of application of the timing gear flexible couple within the kinematic circuit between the engine crankshaft and disc valve.

FIG. 2 Is a frontal view of the disc valve timing gear showing the placement of a flexible member within the said disc valve hub as a flexible driving interface with the timing shaft.

FIG. 3 Is a partial cross-section of the timing gear and timing shaft rotatively mounted in the supporting frame of the engine crankcase.

FIG. 4 Is a perspective view of the resilient member comprising the flexural interface of the timing gear.

### DETAILED DESCRIPTION OF THE INVENTION

The invention is a flexible coupling to be used in the opening and closing mechanism of a disc valve controlling the intake and exhaust flow circuits of an internal combustion engine.

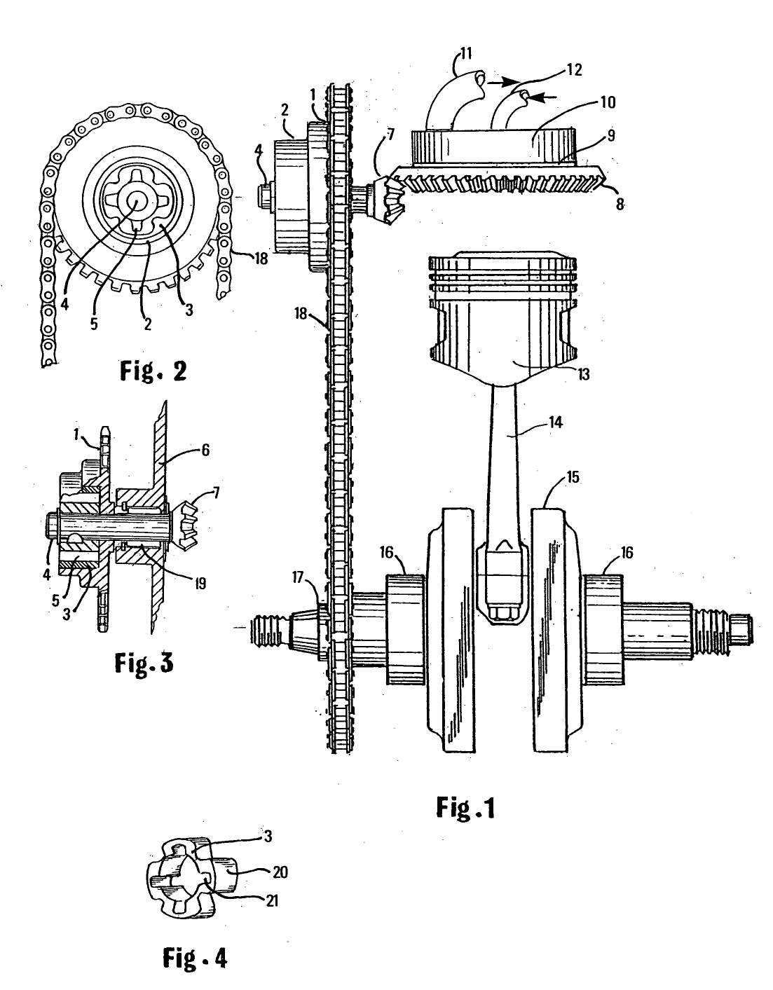

Referring to FIG. 1 of the drawing sheet. FIG. 1 shows the moving components of the engine power train and shows the timing gear 1 and the timing gear hub 2 that holds a resilient member 3 (not shown) that is the flexural element of the timing gear 1 coupling. Timing gear 1 is rotatively mounted on timing shaft 4 which in turn is rotatively mounted in the supporting frame of an engine crankcase. Pinion bevel gear 7 is fixedly mounted at one end of timing shaft 4. Pinion bevel gear 7 engages bevel gear 8 which rotates disc valve 9 in circular sliding contact with stator 10 having a plurality of exhaust ports 11 and intake ports 12. Rotation of disc valve 9 opens and closes the said plurality of exhaust ports 11 and intake ports 12 synergistically in a manner corresponding to the reciprocating translational position of piston 13 in the engine cyclic operating sequence. Piston 13, connecting rod 14 and crankshaft 15 rotating on journaled bearing surfaces 16 comprise the kinematic elements of a reciprocating four-bar system providing rotational movement to crankshaft 15. Crankshaft timing gear 17 is mounted on crankshaft 15 and transmits crankshaft 15 rotational motion to timing gear 1 indirectly through interconnecting driving chain 18 in the sequential manner described.

Those skilled-in-the-art will readily recognize the fact that pinion bevel gear 7 and bevel gear 8 can be replaced with a pinion worm gear and worm gear combination without effecting the novelty of the invention.

Referring now to FIG. 2. FIG. 2 is a frontal view of timing gear 1 showing hub 2, resilient member 3, timing shaft 4, said timing shaft 4 having a plurality of lateral members for engaging resilient member 3, and interconnecting driving chain 18.

Turning now to FIG. 3 showing the inner construction of timing gear 1 and its manner of rotative mounting upon timing shaft 4 and inhibiting this rotation by a resilient member placed between said timing gear 1 and timing shaft 4 coupling them together. Timing shaft 4 is rotatively mounted in needle bearing 19 held in frame 5 of the engine crankcase.

FIG. 4 is a perspective view of the resilient member 3. The outer surfaces of resilient member 3 in contact with timing gear hub 2 contain a plurality of outer sectors 20, in this instance four, which fit into hub 2 having similarly interfacing contours surfaces for securely holding it in said hub and recessed niches 21 for engagement with the lateral members of the timing shaft 4.

### Numbered Elements of the Drawings

1. timing gear
2. hub
3. resilient member
4. timing shaft
5. lateral member
6. frame
7. pinion bevel gear
8. bevel gear
9. disc valve
10. stator
11. exhaust ports
12. intake ports
13. piston
14. connecting rod
15. crankshaft
16. bearing surfaces
17. crankshaft timing gear
18. chain drive
19. needle bearing
20. outer sector
21. niche

1. A timing gear for a disc valve engine, said timing gear having a hub aligned concentrically about its axis of rotation, said hub holding a resilient member fixedly secured by a plurality of matching interfacing sector contours configured in said resilient member and reversely contoured in said hub, said timing gear rotatively mounted on a timing shaft, said timing shaft comprising a bevel gear fixedly attached at one end and a plurality of lateral members fixedly attached at the opposite end, said lateral members passing through the center of said resilient member and in contact with a plurality of recessed niches in said resilient member.

2. The timing gear of claim 1 in which the said pinion bevel gear turning said bevel gear is a worm gear pinion turning a worm gear.

3. The timing gear of claim 1 in which the resilient member is manufactured from a natural rubber compound.

4. The timing gear of claim 1 in which the resilient member is compounded from a synthetic rubber.
